(19) United States
(12) Patent Application Publication
(10) Pub. No.: US 2016/0170982 A1
(43) Pub. Date: Jun. 16, 2016

(54) Method and System for Joint Representations of Related Concepts

(71) Applicant: Yahoo! Inc., Sunnyvale, CA (US)

(72) Inventors: Nemanja Djuric, Mountain View, CA (US); Vladan Radosavljevic, Sunnyvale, CA (US); Hao Wu, Los Angeles, CA (US); Mihajlo Grbovic, Mountain View, CA (US); Narayan Bhamidipati, Mountain View, CA (US)

(21) Appl. No.: 14/572,579

(22) Filed: Dec. 16, 2014

(51) Int. Cl. G06F 17/30; G06N 3/04

(52) U.S. Cl. CPC G06F 17/30011; G06F 17/30707; G06N 3/0472

(57) ABSTRACT

The present teaching relates to joint representation of information. In one example, first and second pieces of information are received. Each of the first and second pieces of information relates to one word in a plurality of documents, one of the documents, or one of user to which the documents are given. A model for estimating feature vectors is obtained. The model includes a first neural network model based on a first order of words within one of the documents and a second neural network model based on a second order in which at least some of the documents are given. Based on the model, a first feature vector of the first piece of information and a second feature vector of the second piece of information are estimated. A similarity between the first and second pieces of information is determined based on a distance between the first and second feature vectors.

### BACKGROUND

1. Technical Field

The present teaching relates to methods, systems, and programming for information processing. More specifically, the present teaching is directed to methods, systems, and programming for representation of information.

2. Discussion of Technical Background

Text documents coming in a sequence are common in real data and can arise in various contexts. For example, consider Web pages surfed by users in random walks along the hyperlinks, streams of click-through URLs associated with a query in search engine, publications of an author in chronological order, threaded posts in online discussion forums, answers to a question in online knowledge sharing communities, or emails replied in a same subject, to name a few. The co-occurrences of documents in a temporal sequence may reveal the relatedness between them, such as their semantic and topical similarity. In addition, sequence of words within the documents introduces another rich and complex source of the data, which can be leveraged to learn useful and insightful representations of information, such as documents and keywords.

This idea of distributed word representations has spurred many applications in natural language processing. For example, some known solutions learn vector representations of words by considering sentences and learning similar representations of words that are either often in the neighborhood of each other (e.g., vectors for “ham” and “cheese”), or not often appear in the neighborhood of each other but have similar neighborhoods (e.g., vectors for “Monday” and “Tuesday”). However, those solutions are not able to represent higher-level entities, such as documents or users, since they use a shallow neural network. This limits the applicability of their method significantly.

More recently, the concept of distributed representations has been extended beyond pure language words to phrases, sentences and paragraphs, general text-based attributes, descriptive text of images, and nodes in a network. For example, some known solutions define a vector for each document and consider this document vector to be in the neighborhood of all word tokens that belong to it. Thus, those known solutions are able to learn document vector that in some sense summarizes the words within. However, those known solutions merely consider the specific document in which the words are contained, but not the global context of the specific document and words, e.g., contextual documents in the document stream or users related to the content. In other words, those known solutions do not model contextual relationships between information at higher-levels, e.g., documents, users, and/or user groups. Thus, such architecture remains shallow.

Therefore, there is a need to provide an improved solution for representation of information to solve the above-mentioned problems.

### SUMMARY

The present teaching relates to methods, systems, and programming for information processing. Particularly, the present teaching is directed to methods, systems, and programming for representation of information.

In one example, a method, implemented on at least one computing device each having at least one processor, storage, and a communication platform connected to a network for determining similarity between information is presented. A first piece of information and a second piece of information are received. Each of the first and second pieces of information relates to one word in a plurality of documents, one of the plurality of documents, or one of user to which the plurality of documents are given. A model for estimating feature vectors of the first and second pieces of information is obtained. The model includes a first neural network model based, at least in part, on a first order of words within one of the plurality of documents and a second neural network model based, at least in part, on a second order in which at least some of the plurality of documents are given. Based on the model, a first feature vector of the first piece of information and a second feature vector of the second piece of information are estimated. A similarity between the first and second pieces of information is determined based on a distance between the first and second feature vectors.

In a different example, a system having at least one processor, storage, and a communication platform for determining similarity between information is presented. The system includes a data receiving module, a modeling module, an optimization module, and a similarity measurement module. The data receiving module is configured to receive a first piece of information and a second piece of information. Each of the first and second pieces of information relates to one word in a plurality of documents, one of the plurality of documents, or one of user to which the plurality of documents are given. The modeling module is configured to obtain a model for estimating feature vectors of the first and second pieces of information. The model includes a first neural network model based, at least in part, on a first order of words within one of the plurality of documents and a second neural network model based, at least in part, on a second order in which at least some of the plurality of documents are given. The optimization module is configured to estimate, based on the model, a first feature vector of the first piece of information and a second feature vector of the second piece of information. The similarity measurement module is configured to determine a similarity between the first and second pieces of information based on a distance between the first and second feature vectors.

Other concepts relate to software for implementing the present teaching on determining similarity between information. A software product, in accord with this concept, includes at least one non-transitory machine-readable medium and information carried by the medium. The information carried by the medium may be executable program code data, parameters in association with the executable program code, and/or information related to a user, a request, content, or information related to a social group, etc.

In one example, a non-transitory machine readable medium having information recorded thereon for determining similarity between information is presented. The recorded information, when read by the machine, causes the machine to perform a series of processes. A first piece of information and a second piece of information are received. Each of the first and second pieces of information relates to one word in a plurality of documents, one of the plurality of documents, or one of user to which the plurality of documents are given. A model for estimating feature vectors of the first and second pieces of information is obtained. The model includes a first neural network model based, at least in part, on a first order of words within one of the plurality of documents and a second neural network model based, at least in part, on a second order in which at least some of the plurality of documents are given. Based on the model, a first feature vector of the first piece of information and a second feature vector of the second piece of information are estimated. A similarity between the first and second pieces of information is determined based on a distance between the first and second feature vectors.

Additional features will be set forth in part in the description which follows, and in part will become apparent to those skilled in the art upon examination of the following and the accompanying drawings or may be learned by production or operation of the examples. The features of the present teachings may be realized and attained by practice or use of various aspects of the methodologies, instrumentalities and combinations set forth in the detailed examples discussed below.

### BRIEF DESCRIPTION OF THE DRAWINGS

The methods, systems, and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is an exemplary illustration of a hierarchical structure of related concepts with global context, according to an embodiment of the present teaching;

FIG. 2 depicts an exemplary architecture of hierarchical neural network models for joint representations of documents and their content, according to an embodiment of the present teaching;

FIG. 3 depicts another exemplary architecture of hierarchical neural network models for joint representations of documents and their content, according to an embodiment of the present teaching;

FIG. 4 depicts an exemplary high level architecture of hierarchical neural network models for joint representations of related concepts, according to an embodiment of the present teaching;

FIG. 5 depicts exemplary inputs and outputs of a hierarchical neural network model based joint representation engine, according to an embodiment of the present teaching;

FIG. 6 is a high level exemplary system diagram of a system for hybrid query based on the joint representation engine in FIG. 5, according to an embodiment of the present teaching;

FIG. 7 is a high level exemplary system diagram of a system for classification based on the joint representation engine in FIG. 5, according to an embodiment of the present teaching;

FIG. 8 is an exemplary diagram of the joint representation engine in FIG. 5, according to an embodiment of the present teaching;

FIG. 9 is a flowchart of an exemplary process for determining similarity between information based on joint representation of information, according to an embodiment of the present teaching;

FIG. 10 is a flowchart of an exemplary process for generating vector representations of training data, according to an embodiment of the present teaching;

FIG. 11 depicts results of an exemplary experiment for providing nearest neighbors of selected keywords;

FIG. 12 depicts results of an exemplary experiment for providing most related news stories for a given keyword;

FIG. 13 depicts results of an exemplary experiment for providing titles of news articles for given news examples;

FIG. 14 depicts results of an exemplary experiment for providing top related words for new stories;

FIG. 15 depicts an exemplary embodiment of a networked environment in which the present teaching is applied, according to an embodiment of the present teaching;

FIG. 16 depicts the architecture of a mobile device which can be used to implement a specialized system incorporating the present teaching; and

FIG. 17 depicts the architecture of a computer which can be used to implement a specialized system incorporating the present teaching.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, systems, components, and/or circuitry have been described at a relatively high-level, without detail, in order to avoid unnecessarily obscuring aspects of the present teachings.

The present disclosure describes method, system, and programming aspects of efficient and effective distributed representation of information, e.g., related concepts, realized as a specialized and networked system by utilizing one or more computing devices (e.g., mobile phone, personal computer, etc.) and network communications (wired or wireless). The method and system as disclosed herein introduce an algorithm that can simultaneously model documents from a stream as well as their residing natural language in a common lower-dimensional vector space. The method and system in the present teaching include a general unsupervised learning framework to uncover the latent structure of contextual documents, where feature vectors are used to represent documents and words in the same latent space. The method and system in the present teaching introduce hierarchical models where document vectors act as units in a context of document sequences and also as global contexts of word sequences contained within them. In the hierarchical models, the probability distribution of a document depends on the surrounding documents in the stream data. The models may be trained to predict words and documents in a sequence with maximum likelihood.

The vector representations (feature vectors) of documents and words learned by the models are useful for various applications in online businesses. For example, by means of measuring the distance in the joint vector space between document and word vectors, hybrid query tasks can be addressed: 1) given a query keyword, search for similar keywords to expand the query (useful in the search product); 2) given a keyword, search for relevant documents such as news stories (useful in document retrieval); 3) given a document, retrieve similar or related documents, useful for news stream personalization and document recommendation; and 4) automatically generate related words to tag or summarize a given document, useful in native advertising or document retrieval. All these tasks are essential elements of a number of online applications, including online search, advertising, and personalized recommendation. In addition, learned vector representations can be used to obtain state-of-the-art classification results. The proposed approach represents a step towards automatic organization, semantic analysis, and summarization of documents observed in sequences.

Moreover, the method and system in the present teaching are flexible and straightforward to add more layers in order to learn additional representations for related concepts. The method and system in the present teaching are not limited to joint representations of documents and their content (words), and can be extended to the higher-level of global contextual information, such as users and user groups. For example, using data with documents specific to a different set of users (or authors), more complex models can be built in the present teaching to additionally learn distributed representations of users. The extensions can be applied to, for example, personalized recommendation and social relationship mining.

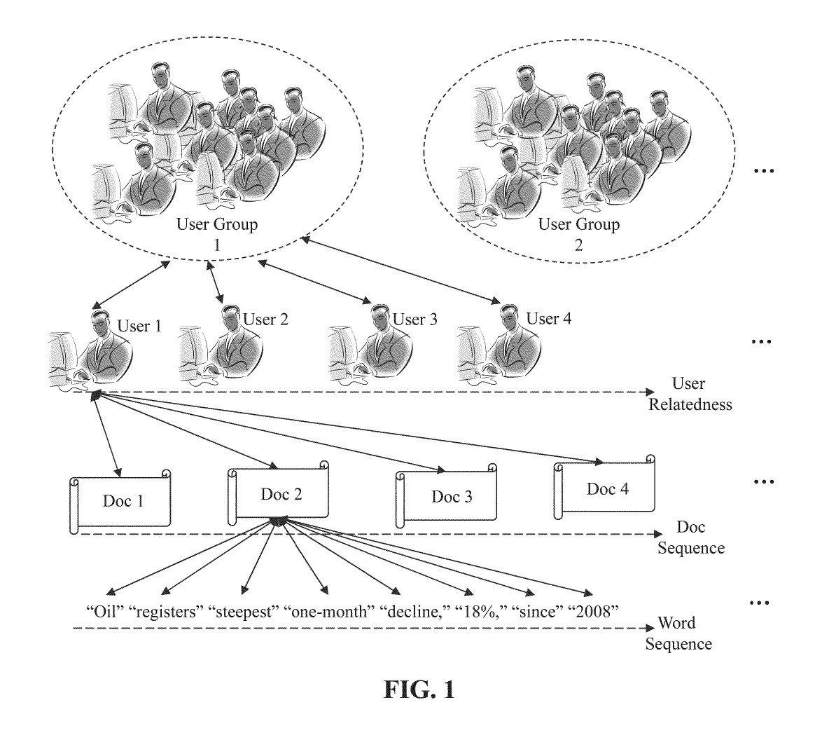

FIG. 1 is an exemplary illustration of a hierarchical structure of related concepts with global context, according to an embodiment of the present teaching. In this example, document content, i.e., words, is at the bottom of the hierarchical structure as the first layer. A sequence of temporally successive words (e.g., one sentence in a news article: “oil registers steepest one-month decline 18% since 2008”) can act as the context to any word in that sequence. For example, n-gram language models and neutral language models are known methods for modeling distributed word representations in natural language processing. One level above the “document content/word layer” in the hierarchical structure, a specific document (Doc 2) where those words appear provides the context of those words. The topic of Doc 2 in this example affects the distributed representations of the words contained therein. Not only the specific document (Doc 2), but also documents that are temporally close to Doc 2 (e.g., Doc 1, Doc 3, Doc 4) when they are served, provide global context of the word sequence. The co-occurrences of those documents in a temporal sequence reveal the relatedness between them, such as their semantic and topical similarity. For example, the topics of Doc 1, Doc 3, and Doc 4 can help reveal the topic of Doc 2, which in turn helps to model the distributed representations of the words in Doc 2.

In this example, the hierarchical structure also includes a “user layer” above the “document layer.” User 1 may be the person who creates or consumes the documents in the document sequence (Doc 1, Doc 2, Doc 3, Doc 4, . . . ). For example, the documents may be recommended to user 1 as a personalized content stream, or user 1 may actively browse those documents in this sequence. In any event, the profile of user 1, e.g., her/his declared or implied interests, demographic information, geographic information, etc., may be taken into consideration in modeling the lower-level concepts in the hierarchical structure, e.g., the distributed representations of the document sequence and/or the word sequences. In addition to user 1 who creates or consumes those documents in FIG. 1, other users who are related to user 1 are also included in the “user layer” of the hierarchical structure as part of the global context of the lower-level concepts. The relatedness of users reveals the profiles of those users. The relatedness may be determined in various ways, for example, by declared relationships such as husband/wife or parents/child relations, or by implied relationships such as connections through social networks. The hierarchical structure continuously extends in FIG. 1 to another layer above the “user layer,” which is the “user group layer.” The related users in this example (user 1, user 2, user 3, user 4, . . . ) belong to the same user group 1. The user groups in this example may be a family, a company, a political party, or any other suitable social groups. Users belong to a particular user group because they share at least one common characteristic, such as the blood relation in a family, the same political views in a political party, etc. Those common characteristics shared by users in a user group can also help identifying the user profiles of its members. If social relationships between different user groups are known, such as competing companies in the same industrial or close families, then those social relationships may become part of the global context in the “user group layer” as well for modeling the lower-level concepts. If information in the “user group layer” is used as the global context, then it can be applied for concepts in any lower-layers in the hierarchical structure, e.g., for modeling distributed representations of users, documents, and/or words.

It is understood that the context is not only provided by higher-level concepts to lower-level concepts as described above, but can also be provided by lower-level concepts to higher-level concepts. For example, the word sequence may be used as the context for modeling the representation of Doc 2 and/or other documents in the document sequence. In another example, the document sequence may be used as the context for estimating the profile of user 1 and/or other related users. In some embodiments, both higher-level concepts and lower-level concepts may be served as the global context together. For example, in modeling distributed representations of the document sequence, both related users and content (word sequences) of those documents may be used as the global context.

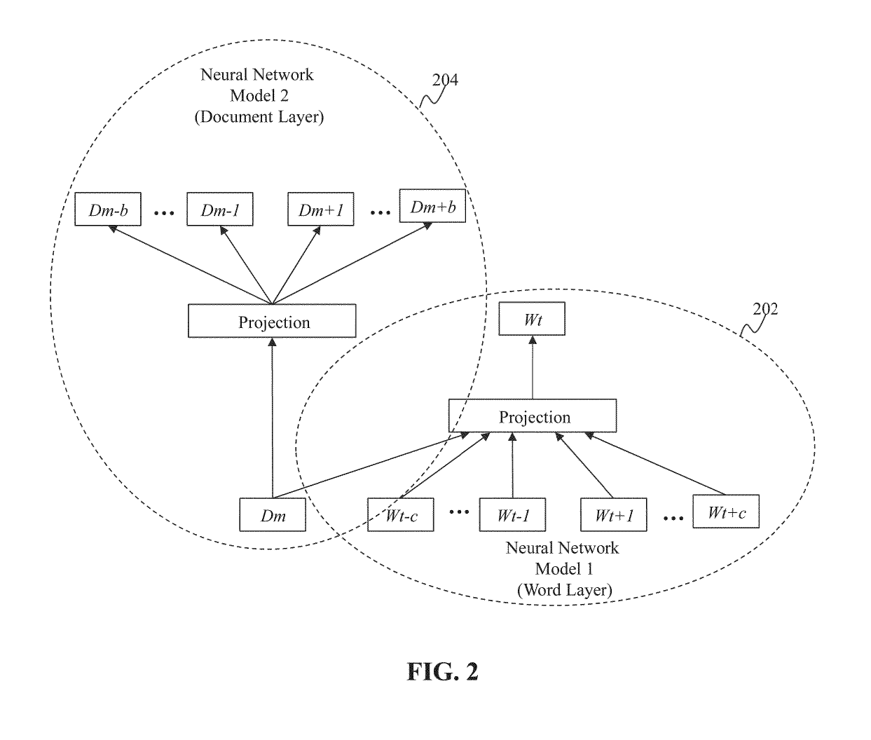

FIG. 2 depicts an exemplary architecture of hierarchical neural network models for joint representations of documents and their content, according to an embodiment of the present teaching. This example models a two-layer hierarchical structure of documents and their content. The hierarchical neural network models include a first neural network model 202 that models the “document content/word layer” and a second neural network model 204 that models the “document layer.”

The training documents in this example are given in a sequence. For example, if the documents are news articles, a document sequence can be a sequence of news articles sorted in an order in which the user read them. More specifically, assuming that a set S of S document sequences S=[s₁, s₂, . . . , sₛ] is given, each consisting of Nᵢ documents sᵢ=(d₁, d₂, . . . , d_{Ni}). Moreover, each document is a sequence of Tₘ words dₘ=(w₁, w₂, . . . , w_{Tm}). The hierarchical neural network models in this example simultaneously learn distributed representations of contextual documents and language words in a common vector space and represent each document and word as a continuous feature vector of dimensionality D. Suppose there are M unique documents in the training data set, W unique words in the vocabulary, then during training, (M+W) D model parameters are learned.

The context of document sequence and the natural language context are learned using hierarchical neural network models of this example, where document vectors act not only as the units to predict their surrounding documents, but also the global context of word sequences within them. The second neural network model 204 learns the temporal context of document sequence, based on the assumption that temporally closer documents in the document stream are statistically more dependent. The first neural network model 202 makes use of the contextual information of word sequences. The two neural network models 202, 204 are connected by considering each document token as the global context for all words within the document. In this example, the document Dm is not only used in the second neural network model 204, but also as the global context for projecting the word within the document in the first neural network model 202.

In this example, given sequences of documents, the objective of the hierarchical model is to maximize the average data log-likelihood,

$$ℒ = \frac{1}{S} ( {\sum }_{s ∈ S} ( \begin{matrix}{\sum }_{{d}_{m} ∈ s} {\sum }_{- b \leq i \leq b , i \neq 0} log ℙ ( {d}_{m + 1} \vert {d}_{m} ) + \\ α {\sum }_{{d}_{m} ∈ s} {\sum }_{{w}_{t} ∈ {d}_{m}} log ℙ ( {w}_{t} \vert {w}_{t - c} \text{:} {w}_{t + c} , {d}_{m} )\end{matrix} ) ) , \qquad ( 1 )$$

where a is the weight that trades off between focusing on minimization of the log-likelihood of document sequence and the log-likelihood of word sequences (set to 1 in the experiments described below), b is the length of the training context for document sequences, and c is the length of the training context for word sequences. In this example, continuous skip-gram (SG) model is used as the first neural network model 202, and continuous bag-of-words (CBOW) model is used as the second neural network model 204. It is understood that any suitable neural network models, such as but not limited, to n-gram language model, log-bilinear model, log-linear model, SG model, or CBOW model, can be used in any layer and the choice depends on the modalities of the problem at hand.

The CBOW model is a simplified neural language model without any non-linear hidden layers. A log-linear classifier is used to predict current word based on consecutive history and future words, where their vector representations are averaged as the input. More precisely, the objective of the CBOW model is to maximize the average log probability.

$$ℒ = \frac{1}{T} {\sum }_{t = 1}^{T} log ℙ ( {w}_{t} \vert {w}_{t - c} \text{:} {w}_{t + c} ) , \qquad ( 2 )$$

where c the context length, and w_{t-c}:w_{t+c} is the subsequence (w_{t-c}, . . . , w_{t+c}) excluding wₜ itself. The probability [symbol] (wₜ|w_{t-c}:w_{t+c}) is defined using the softmax,

$$ℙ ( {w}_{t} \vert {w}_{t - c} \text{:} {w}_{t + c} ) = \frac{exp ( {\overline{v}}^{T} {v}_{{w}_{t }}^{′} )}{{\sum }_{w = 1}^{W} exp ( {\overline{v}}^{T} {v}_{w}^{′} )} , \qquad ( 3 )$$

where v′_{w}_{ₜ} is the output vector representation of wₜ, and v̅ is averaged vector representation of the context, computed as

$$\overline{v} = \frac{1}{2 c} {\sum }_{- c \leq j \leq c , j \neq 0} {v}_{{w}_{i + j}} , \qquad ( 4 )$$

where v_{w} is the input vector representation of w.

SG model tries to predict the surrounding words within a certain distance based on the current one. SG model defines the objective function as the exact counterpart to CBOW model,

$$ℒ = \frac{1}{T} {\sum }_{t = 1}^{T} log ℙ ( {w}_{t - c} \text{:} {w}_{t + c} \vert {w}_{t} ) . \qquad ( 5 )$$

Furthermore, SG model simplifies the probability distribution, introducing an assumption that the contextual words w_{t-c}:w_{t+c} are independent given current word wₜ,

$$ℙ ( {w}_{t - c} \text{:} {w}_{t + c} \vert {w}_{t} ) = {\prod }_{- c \leq j \leq - c , j \neq 0} ℙ ( {w}_{t + j} \vert {w}_{t} ) , \qquad ( 6 )$$

with [symbol] (wₜ₊ⱼ|wₜ) defined as

$$ℙ ( {w}_{t + j} \vert {w}_{t} ) = \frac{exp ( {v}_{{w}_{t}}^{T} {v}_{t + j}^{′} )}{{\sum }_{w = 1}^{W} exp ( {v}_{{w}_{t}}^{T} {v}_{w}^{′} )} , \qquad ( 7 )$$

where v_{w} and v′_{w} are the input and output vectors of w, respectively. Increasing the range of context c would generally improve the quality of learned word vectors, but at the expense of higher computation cost. SG model considers the surrounding words are equivalently important, and in this sense the word order is not fully exploited, similar to CBOW model.

Returning back to Equation 1, the probability of observing a surrounding document based on the current document [symbol] (d̅ₘ₊ᵢ|dₘ) is defined using a soft-max function,

$$ℙ ( {d}_{m + i} \vert {d}_{m} ) = \frac{exp ( {v}_{{d}_{m}}^{T} {v}_{{d}_{m + i}}^{′} )}{{\sum }_{d = 1}^{N} exp ( {v}_{{d}_{m}}^{T} {v}_{d}^{′} )} , \qquad ( 8 )$$

where v_{d} and v′_{d} are the input and output vector representations of document d, respectively. The probability of observing a word not only depends on its surrounding words, but also the specific document that the word belongs to. More precisely, probability [symbol] (wₜ|w_{t-c}:w_{t+c}, dₘ) defined as

$$ℙ ( {w}_{t} \vert {w}_{t - c} \text{:} {w}_{t + c} , {d}_{m} ) = \frac{exp ( {\overline{v}}^{T} {v}_{{w}_{t}}^{′} )}{{\sum }_{w = 1}^{W} exp ( {\overline{v}}^{T} {v}_{w}^{′} )} , \qquad ( 9 )$$

where v′_{wt} is the output vector representation of wₜ, and v̅ is the averaged vector representation of the context (including the specific dₘ), defined as

$$\overline{v} = \frac{1}{2 c + 1} ( {v}_{{d}_{m}} + {\sum }_{- c \leq j \leq c , j \neq 0} {v}_{{w}_{t + j}} ) . \qquad ( 10 )$$

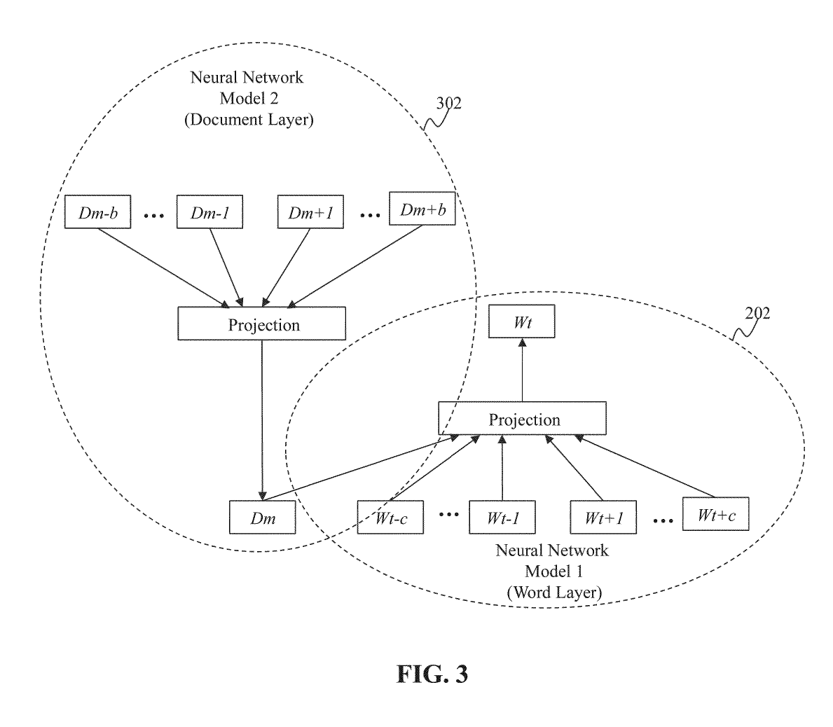

FIG. 3 depicts another exemplary architecture of hierarchical neural network models for joint representations of documents and their content, according to an embodiment of the present teaching. FIG. 2 shows an exemplary model architecture with specified language models in each layer of the hierarchical model. In some embodiments, the hierarchical neural network models may be varied for different purposes. For example, a news website would be interested in predicting on the fly which news article a user would read after a few clicks on some other news stories, in order to personalize the news feed. Then, it would be more reasonable to use directed, feed-forward models which estimate [symbol] (dₘ|d_{m-b}:dₘ₋₁), i.e., the probability of the mth document in the sequence given its preceding documents. This is reflected, for example, in the second neural network model 302 of FIG. 3. Different from the second neural network model 204 of FIG. 2, the arrow directions (inputs and outputs) are reversed because the surround documents in a sequence (Dm−b, . . . , Dm−1, Dm+1, . . . , Dm+b) now serve as the global context for predicting Dm. Or, in some embodiments, to model which documents were read prior to the currently observed sequence, feed-backward models which estimate [symbol] (dₘ|dₘ₊₁:d_{m+b}), i.e., the probability of the mth document given its b succeeding documents, are applied.

From this example, it is understood that the inputs and outputs in each of the hierarchical neural network models for modeling each layer of concepts may be reversed as needed. For example, the inputs and outputs of the first neural network model 202 may be reversed in some embodiments such that it can learn the temporal context of word sequence for the word Wt.

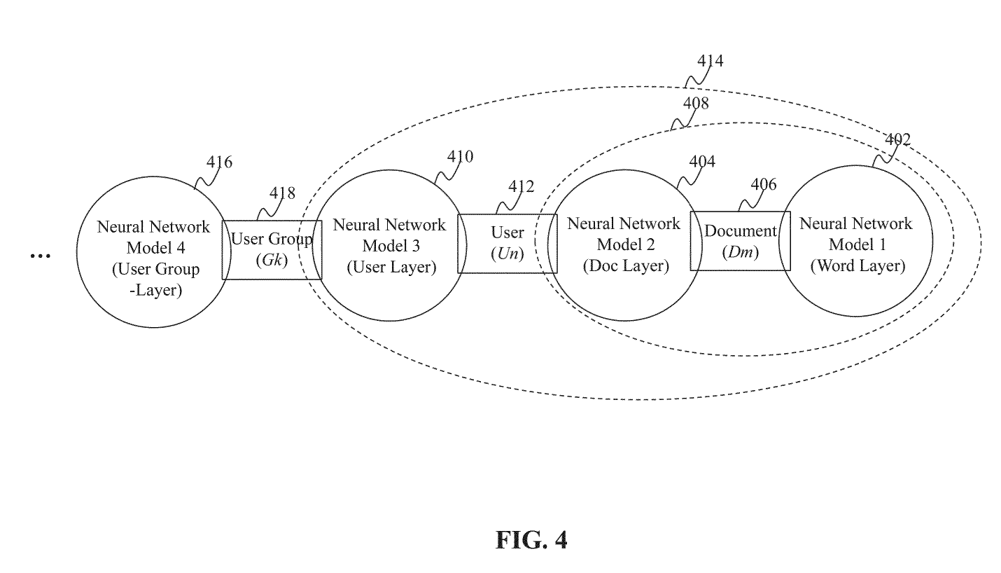

FIG. 4 depicts an exemplary high level architecture of hierarchical neural network models for joint representations of related concepts, according to an embodiment of the present teaching. As described above with respect to FIG. 1, the hierarchical neural network models may be extended to higher-level of concepts. As shown in FIG. 4, more complex models are built to additionally learn distributed representations of users and user groups by adding additional user and user group layers on top of the document layer.

In this example, the first layer of the hierarchical neural network models is the first neural network model 402 for document content/words. On top of the first neural network model 402, the second neural network model 404 for documents is added and connected to the first neural network model 402 by the document Dm 406. Dm 406 may be the document that contains the word sequence in the first neural network model 402 as described above with respect to FIG. 2. The first and second neural network models 402, 404 may be viewed as a combined neural network model 408 for documents and their content.

The third neural network model 410 for users and the second neural network model 404 are arranged in a cascade of models in this example. The third neural network model 410 is connected to the second neural network model 404 via the user Un 412. The documents in the second neural network model 404 may be specific to Un 412. For example, the documents may be personalized content stream for Un 412, or Un 412 may be the author or consumer of the documents. Then, Un 412 could serve as the global context of contextual documents pertaining to that specific user, much like Dm 406 serves as the global context to words pertaining to that specific document. For example, a document may be predicted based on the surrounding documents, which also conditioning on a specific user. This variant model can be represented as [symbol] (dₘ|d_{m-b}:dₘ₋₁, u), where u denotes the indicator for the user. Learning vector representations of users would open doors for further improvement of personalization. The first, second, and third neural network models 402, 404, 410 may be viewed as a combined neural network model 414 for users, documents, and document content.

The fourth neural network model 416 for user groups is also part of the cascade of models in this example. The fourth neural network model 416 is connected to the third neural network model 410 via the user group Gk 418. The users in the third neural network model 410 may belong to Gk 418. For example, all the users may be in the same family. Then, Gk 418 could serve as the global context of contextual users pertaining to that specific user group, much like Dm 406 serves as the global context to words pertaining to that specific document and Un 412 servers as the global context to documents pertaining to that specific user. Learning vector representations of user groups would open doors for further improvement of social relationship mining. It is understood that the neural network models in this example may be continuously extended by cascading more neural network models for related concepts at other levels.

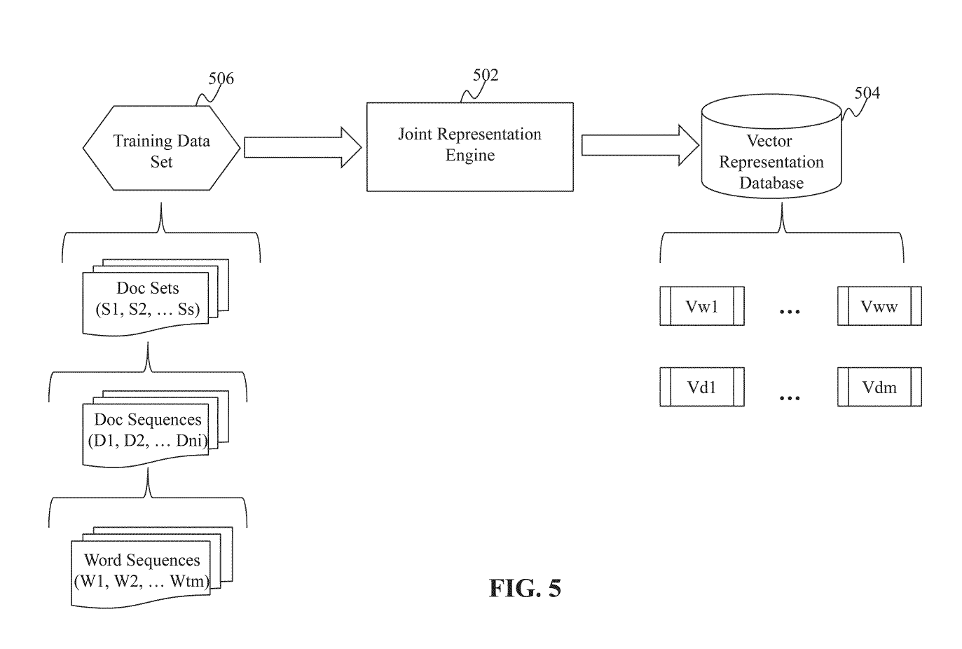

FIG. 5 depicts exemplary inputs and outputs of a hierarchical neural network model-based joint representation engine, according to an embodiment of the present teaching. A joint representation engine 502 in this example receives training data in the training data set 506. Based on any suitable neural network models disclosed in the present teaching, the joint representation engine 502 estimates vector representations (feature vectors) for concepts in the training data set 506, and stores them in the vector representation database 504. In this example, all the vector representations are in a common feature space and thus, can be compared by measuring the distances therebetween. In this example, the training data set includes S document sequences S=[s₁, s₂, . . . , sₛ], each consisting of Nᵢ documents sᵢ=(d₁, d₂, . . . , d_{Ni}). Moreover, each document is a sequence of Tₘ words dₘ=(w₁, w₂, . . . , w_{Tm}). The joint representation engine 502 in this example simultaneously learns distributed representations of contextual documents and language words in a common vector space and represents each document and word as a continuous feature vector of dimensionality D. Suppose there are M unique documents in the training data set 506, W unique words in the vocabulary, then vector representations of the M documents (Vd1, . . . , Vdm) and vector representations of the W words (Vw1, Vww) are estimated and stored in the vector representation database 504.

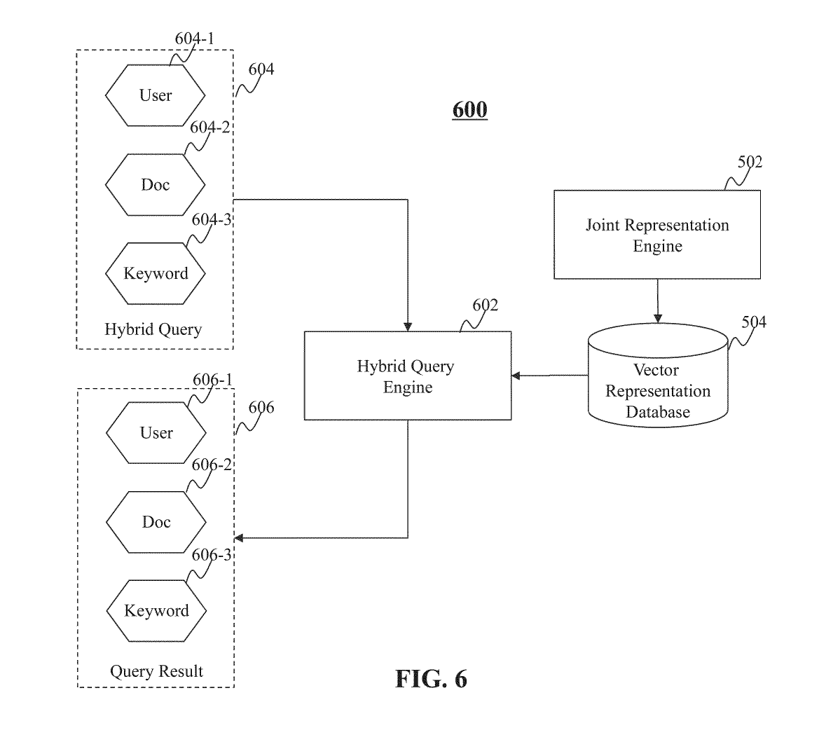

FIG. 6 is a high level exemplary system diagram of a system for hybrid query based on the joint representation engine in FIG. 5, according to an embodiment of the present teaching. In this example, a system 600 for hybrid query includes the joint representation engine 502, the vector representation database 504, and a hybrid query engine 602. As described above, the joint representation engine 502 can estimate vector representations of various types of information/concepts, e.g., keywords, documents, users, or user groups, in a common vector space with the same dimensionality. Thus, the similarity between any of the concepts, regardless of whether they are of the same type (e.g., both concepts are documents) or not (e.g., one concept is a document while the other is a keyword), can be determined by measuring the distance between their vector representations, e.g., cosine distance in the common embedding space. In some embodiments, the similarity measure may be a Hamming distance or a Euclidean distance between the vectors in the common space. The similarity represents the degree of relevance between the two concepts and thus, can be used for hybrid query by the hybrid query engine 602. If the degree of similarity between two pieces of information (concepts) is above a threshold, then hybrid query engine 602 considers one as the query result for the other one (query). In this example, the hybrid queries 604 include, for example, users 604-1, documents 604-2, and keywords 604-3, and the query results 606 include, for example, users 606-1, documents 606-2, and keywords 606-3.

The hybrid query tasks that can be addressed by the hybrid query engine 602 in this example include: 1) given a query keyword, search for similar keywords to expand the query (useful in the search product); 2) given a keyword, search for relevant documents such as news stories (useful in document retrieval); 3) given a document, retrieve similar or related documents, useful for news stream personalization and document recommendation; and 4) automatically generate related words to tag or summarize a given document, useful in native advertising or document retrieval. All these tasks are essential elements of a number of online applications, including online search, advertising, and personalized recommendation.

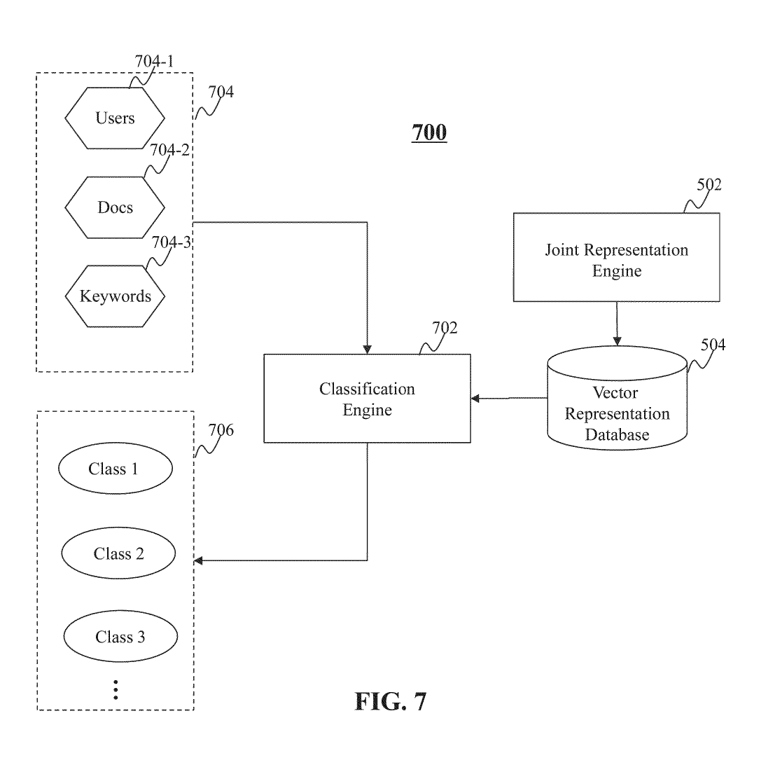

FIG. 7 is a high level exemplary system diagram of a system for classification based on the joint representation engine in FIG. 5, according to an embodiment of the present teaching. In this example, a system 700 for classification includes the joint representation engine 502, the vector representation database 504, and a classification engine 702. As described above, the joint representation engine 502 can estimate vector representations (feature vectors) of various types of information/concepts, e.g., keywords, documents, users, or user groups, in a common vector space with the same dimensionality. Thus, the similarity between any of the concepts, regardless of whether they are of the same type (e.g., both concepts are documents) or not (e.g., one concept is a document while the other is a keyword), can be determined by measuring the distance between their vector representations, e.g., cosine distance in the common embedding space. In some embodiments, the similarity measure may be a Hamming distance or a Euclidean distance between the vectors in the common space. The similarity represents the degree of relevance between the two concepts and thus, can be used for classification. In this example, the input concepts to be classified include, for example, users 704-1, documents 704-2, and keywords 704-3. Based on the closeness of their vector representations, the classification engine 702 can classify input concepts 704 into different classes 706. The classes 706 may include class of the same type of concepts, e.g., various user classes or documents classes, and class across different types of concepts. For example, any type of concepts that are closely related to each other, e.g., all related to the same topic, may be classified into the same class. For example, a class related to “007” movies may include documents related to any “007” movie and actors/actress played in any “007” movie.

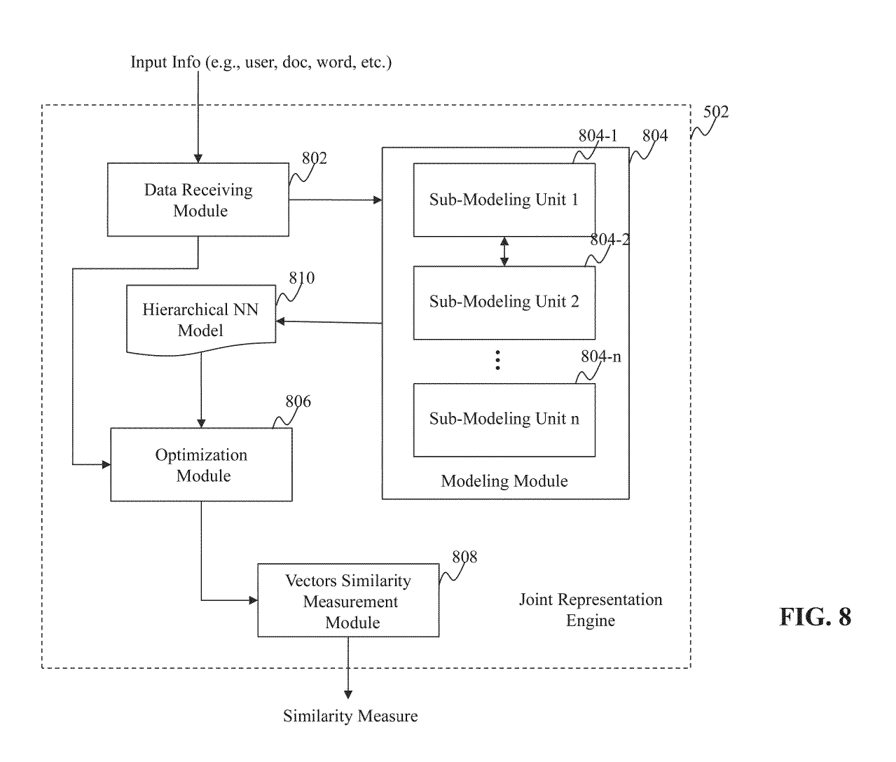

FIG. 8 is an exemplary diagram of the joint representation engine in FIG. 5, according to an embodiment of the present teaching. The joint representation engine 502 in this embodiment includes a data receiving module 802, a modeling module 804, an optimization module 806, and a vectors similarity measurement module 808. The data receiving module 802 is configured to receive input information. The input information may be any concepts, such as but not limited to, words, documents, users, and user groups. The modeling module 804 in this example is responsible for obtaining a model for estimating feature vectors of the input information. Any hierarchical neural network models 810 for joint representations of related concepts as disclosed in the present teaching may be obtained by the modeling module 804, such as the model represented by Equation 1. The modeling module 804 in this example includes multiple sub-modeling units 804-1, 804-2, . . . , 804-n, each of which is configured to obtain a neural network model based on the input information and the specific application of the models. For example, the sub-modeling unit 804-1 may obtain a model based, at least in part, on an order of words within a document, such as the model represented by Equations 9 and 10; the sub-modeling unit 804-2 may obtain a model based, at least in part, on an order in which the surrounding documents are given, such as the model represented by Equation 8. Additional sub-modeling units may be used to obtain other models, for example, for modeling the user layer and user group layer in the hierarchical structure of related concepts, e.g., the third and fourth neural network models 410, 416 in FIG. 4.

The optimization module 806 in this example is configured to estimate, based on the hierarchical neural network model 810, feature vectors of the input information. The feature vectors may be estimated by automatically optimizing the hierarchical neural network model 810. In some embodiments, the hierarchical neural network model 810 is optimized using stochastic gradient descent. In this embodiment, the hierarchical softmax approach is used for automatically optimizing the hierarchical neural network model 810. The hierarchical softmax approach reduces the time complexity to (R log(W)+2bM log(N)), where R is the total number of words in the document sequence. Instead of evaluating each distinct word or document in different entries in the output, the hierarchical softmax approach uses two binary trees, one with distinct documents as leaves and the other with distinct words as leaves. For each leaf node, there is unique path assigned and the path is encoded using binary digits. To construct the tree structure, Huffman tree may be used, where more frequent words (or documents) in data have shorter codes. The internal tree nodes are represented as real-valued vectors, of the same dimensionality as word and document vectors. More precisely, the hierarchical softmax approach expresses the probability of observing the current document (or word) in the sequence as a product of probabilities of the binary decisions specified by the Huffman code of the document as follows,

$$ℙ ( {d}_{m + i} \vert {d}_{m} ) = {\prod }_{l} ℙ ( {h}_{l} \vert {q}_{l} , {d}_{m} ) , \qquad ( 11 )$$

where hₗ is the l^{th} bit in the code with respect to qₗ, which is the l^{th} node in the specified tree path of dₘ₊ᵢ. The probability of each binary decision is defined as follows,

p(hₗ=1|qₗ,dₘ)= [symbol] (v^{T}_{d}_{ₘ}v_{ql}, (12)

where σ(x) is the sigmoid function, and v_{qi} is the vector representation of node qₗ. It can be verified that Σ_{d=1}^{N} [symbol] (dₘ₊ᵢ=d|dₘ)=1, and hence the property of probability distribution is preserved. Similarly, [symbol] (wₜ|w_{t-c}:w_{t-c}, dₘ) can be expressed in the same manner, but with construction of a separate, word-specific Huffman tree. It is understood that any other suitable approach known in the art may be applied to optimize the hierarchical neural network model 810 as well.

The vectors similarity measurement module 808 in this example determines similarity between any two or more pieces of input information based on a distance between their feature vectors. In one example, a cosine distance, a Hamming distance, or a Euclidean distance may be used as the metric of similarity measure. The vector representations in this example are all in the common vector space with the same dimensionality, and thus, can be compared directly by their distance therebetween. In this example, the dimensionality of the common vector space may be in the order of hundreds.

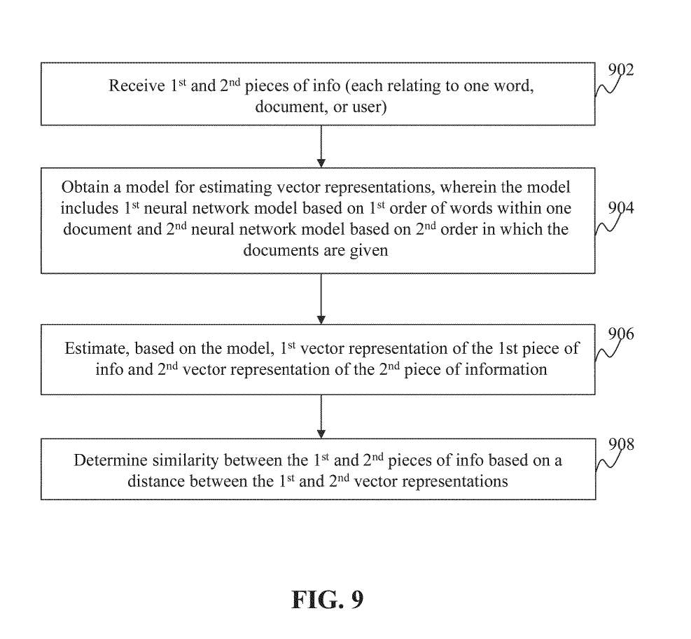

FIG. 9 is a flowchart of an exemplary process for determining similarity between information based on joint representation of information, according to an embodiment of the present teaching. At 902, first and second pieces of information are received. In this example, each of the first and second pieces of information relates to one word in a plurality of documents, one of the plurality of documents, or one of user to which the plurality of documents are given. At 904. A model for estimating feature vectors is obtained. In this example, the model includes a first neural network model based, at least in part, on a first order of words within one of the plurality of documents. The model also includes a second neural network model based, at least in part, on a second order in which at least some of the plurality of documents are given. The first neural network model is based, at least in part, on the document that contains the words in the first order. The at least some of the plurality of documents given in the second order include the document that contains the words in the first order. In some embodiments, the second neural network model may be based, at least in part, on a user to which the at least some of the plurality of documents are given in the second order, and the model further includes a third neural network model based, at least in part, on relationship between at least some of the users to which the plurality of documents are given.

At 906, based on the obtained model, first and second feature vectors are estimated for the first and second pieces of information, respectively. In one example, the first and second feature vectors are estimated by automatically optimizing the model using a hierarchical softmax approach. At 908, the similarity between the first and second pieces of information is determined based on a distance between the first and second feature vectors. The similarity may be used for hybrid query task in which the first and second pieces of information are input query and query result, respectively. The similarity may also be used for classifying the first and second pieces of information based on the determined similarity between the first and second pieces of information.

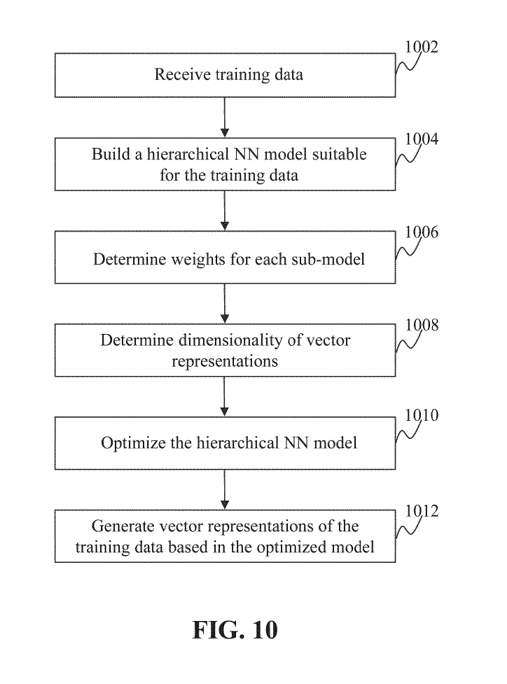

FIG. 10 is a flowchart of an exemplary process for generating feature vectors of training data, according to an embodiment of the present teaching. At 1002, a training data is received. At 1004, a hierarchical neural network model suitable for the training data is built. At 1006, weights for each sub-model in the hierarchical neural network model are determined. For example, in Equation 1, α is the weight that trades off between focusing on minimization of the log-likelihood of document sequence and the log-likelihood of word sequences. The weight may be set at an initial value by prior knowledge and experience and optimized through cross validation. At 1008, the dimensionality of feature vectors (number of features) is determined. In one example, the dimensionally may be 200 to 300. At 1010, the hierarchical neural network model is automatically optimized, for example, by the hierarchical softmax approach or stochastic gradient descent. At 1012, feature vectors of concepts in the training data are generated based on the optimization of the hierarchical neural network model.

The method and system in the present teaching have been evaluated by preliminary experiments as described below in details. In the first set of experiments, the quality of the distributed document representations obtained by the method and system in the present teaching is evaluated on classification tasks. In the experiments, the training data set is a public movie ratings data set MovieLens 10M (http://grouplens.org/datasets/movielens/, September 2014), consisting of movie ratings for around 10,000 movies generated by more than 71,000 users, with a movie synopses data set found online (ftp://ftp.fu-berlin.de/pub/misc/movies/database/, September 2014). Each movie is tagged as belonging to one or more genres, such as “action” or “horror.” Then, following terminology used in the present teaching, movies are considered as “documents” and synopses are considered as “content/words.” The document streams were obtained by taking for each user movies rated 4 and above (on the scale from 1 to 5), and ordering them in a sequence by the timestamp of the rating. This resulted in 69,702 document sequences comprising 8,565 movies.

Several assumptions are made while generating the movie data set. First, only high-rated movies are used in order to make the data less noisy, as the assumption is that the users are more likely to enjoy two movies that belonged to the same genre, than two movies coming from two different genres. Thus, by removing low-rated movies, the experiments aim to retain only similar movies in a single user's sequence. The experimental results as shown below indicate that the assumption is true. In addition, the ratings timestamp is used as a proxy for a time when the movie was actually watched. Although this might not always hold in reality, the empirical results suggest that the assumption was reasonable for learning useful movie and word embedding.

As comparisons, movie vector representations for the training data set are also learned by some known solutions: (1) latent Dirichlet allocation (LDA), which learns low-dimensional representations of documents (i.e., movies) as a topic distribution over their synopses; (2) paragraph vector (paragraph2vec), where the entire synopses are taken as a single paragraph; and (3) word2vec, where movie sequences are used as “documents” and movies as “words.” The method and system in the present teaching are referred as hierarchical document vector (HDV). Note that LDA and paragraph2vec only take into account the content of the documents (i.e., movie synopses), word2vec only considers the movie sequences and does not consider synopses in any way, while HDV combines the two approaches and jointly considers and models both the movie sequences and the content of movie synopses. Dimensionality of the embedding space was set to 100 for all low-dimensional embedding methods, and the neighborhood of the neural language modelling methods was set to 5. A linear support vector machine (SVM) was used to predict a movie genre in order to reduce the effect of variance of non-linear methods on the results.

The classification results after 5-fold cross validation are shown in TABLE 1, where results are reported on eight binary classification tasks for eight most frequent movie genres in the training data set. As shown in TABLE 1, neural language models obtained higher accuracy than LDA on average, although LDA achieved very competitive results on the last six tasks. It is interesting to observe that word2vec obtained higher accuracy than paragraph2vec despite the fact that the latter was specifically designed for document representation, which indicates that the users have strong genre preferences that were exploited by word2vec. Note that the method and system in the present teaching (HDV) achieved higher accuracy than the known solutions, obtaining on average 5.62% better performance over the state-of-the-art paragraph2vec and 1.52% over the word2vec model. This can be explained by the fact that the method and system in the present teaching (HDV) successfully exploited both the document content and the relationships in a stream between them, resulting in improved performance.

TABLE 1
Accuracy on movie genre classification tasks

| Algorithm | drama | comedy | thriller | romance | action | crime | adventure | horror |
|---|---|---|---|---|---|---|---|---|
| LDA | 0.5544 | 0.5856 | 0.8158 | 0.8173 | 0.8745 | 0.8685 | 0.8765 | 0.9063 |
| paragraph2vec | 0.6367 | 0.6767 | 0.7958 | 0.7919 | 0.8193 | 0.8537 | 0.8524 | 0.8699 |
| word2vec | 0.7172 | 0.7449 | 0.8102 | 0.8204 | 0.8627 | 0.8692 | 0.8768 | 0.9231 |
| HDV | 0.7274 | 0.7487 | 0.8201 | 0.8233 | 0.8814 | 0.8728 | 0.8854 | 0.9872 |

In another news topic classification experiment, the learned representations are used to label news documents with the 19 first-level topic tags from a large Internet company's internal hierarchy (e.g., “home & garden,” “science”). A large-scale training data set was collected at servers of the company. The data consists of nearly 200,000 distinct news stories, viewed by a subset of company's users from March to June, 2014. After pre-processing where the stopwords are removed, the hierarchical neural network models in the present teaching are trained on 80 million document sequences generated by users, containing a total of 100 million words and with a vocabulary size of 161 thousands. Linear SVM is used to predict each topic separately, and the average improvement over LDA after 5-fold cross-validation is given in TABLE 2. Note that the method and system in the present teaching (HDV) outperformed the known solutions on this large-scale problem, strongly confirming the benefits of the method and system in the present teaching (HDV) for contextual document representation.

TABLE 2
Relative average accuracy improvement over the LDA method

| Algorithm | Avg. accuracy improvement |
|---|---|
| LDA | 0.00% |
| paragraph2vec | 0.27% |
| word2vec | 2.26% |
| HDV | 4.39% |

In the second sets of experiments, the applications of the method and system in the present teaching on hybrid query are evaluated. The experiment results show a wide potential of the method and system in the present teaching for online applications, using the large-scale training data set collected at servers of the large Internet company as mentioned above. In the second sets of experiments, cosine distance is used to measure the closeness of two vectors, i.e., similarity (either document or word) in the common embedding space.

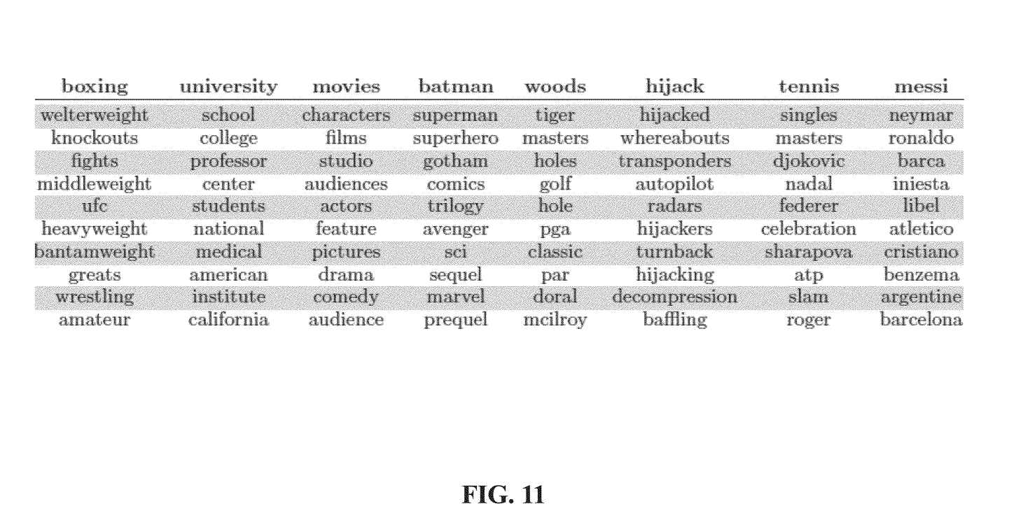

FIG. 11 depicts results of an exemplary experiment for providing nearest neighbors of selected keywords. Given an input word as a query, the experiment aims to find nearest words in vector space by the method and system in the present teaching. This is useful in the setting of, for example, search retargeting, where advertisers bid on search keywords related to or describing their product or service, and may use the hierarchical neural network models in the present teaching to expand the list of targeted keywords. FIG. 11 shows example keywords from the vocabulary, together with their nearest word neighbors in the embedding space. Clearly, meaningful semantic relationships and associations can be observed within the closest distance of the input keywords. For example, for the query word “batman,” the method and system in the present teaching found that other superheroes such as “superman” and “avengers” are related, and also found keywords related to comics in general, such as “comics,” “marvel,” or “sequel.”

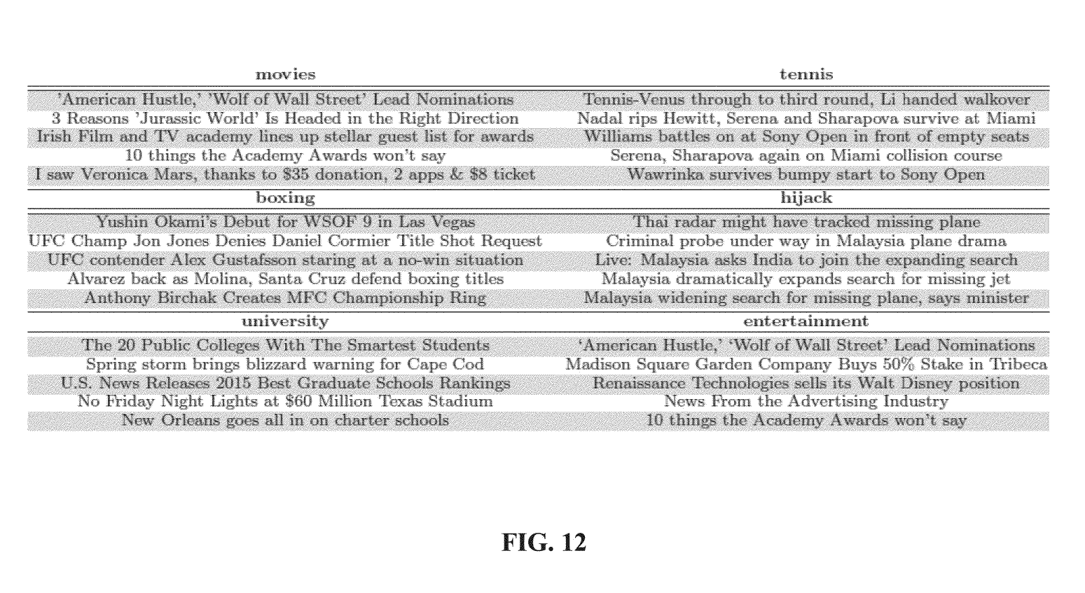

FIG. 12 depicts results of an exemplary experiment for providing most related news stories for a given keyword. Given a query word, one may be interested in finding the most relevant documents, which is a typical task an online search engine performs. The same keywords used in the experiment of FIG. 11 are used in this experiment to find the titles of the closest document vectors. As shown in FIG. 12, the retrieved documents are semantically related to the input keyword. In some cases it might seem that the document is irrelevant, as, for example, in the case of keyword “university” and headlines “Spring storm brings blizzard warning for Cape Cod” and “No Friday Night Lights at $60 Million Texas Stadium.” After closer inspection and a search for the headlines in a popular search engine, it is noted that the snow storm from the first headline affected school operations and the article includes a comment by an affected student. I can also be seen that the second article discussed school facilities and an education fund. Although the titles may be misleading, it is noted that the both articles are of interest to users interested in keyword “university,” as the method and system in the present teaching correctly learned from the actual user sessions.

Note that the method and system in the present teaching differ from the traditional information retrieval due to the fact that the retrieved document does not need to contain the query word, as seen in the example of keyword “boxing.” As we can see, the method and system in the present teaching found that the articles discussing UFC and WSOF events are related to the sport, despite the fact that they don't specifically contain word “boxing.”

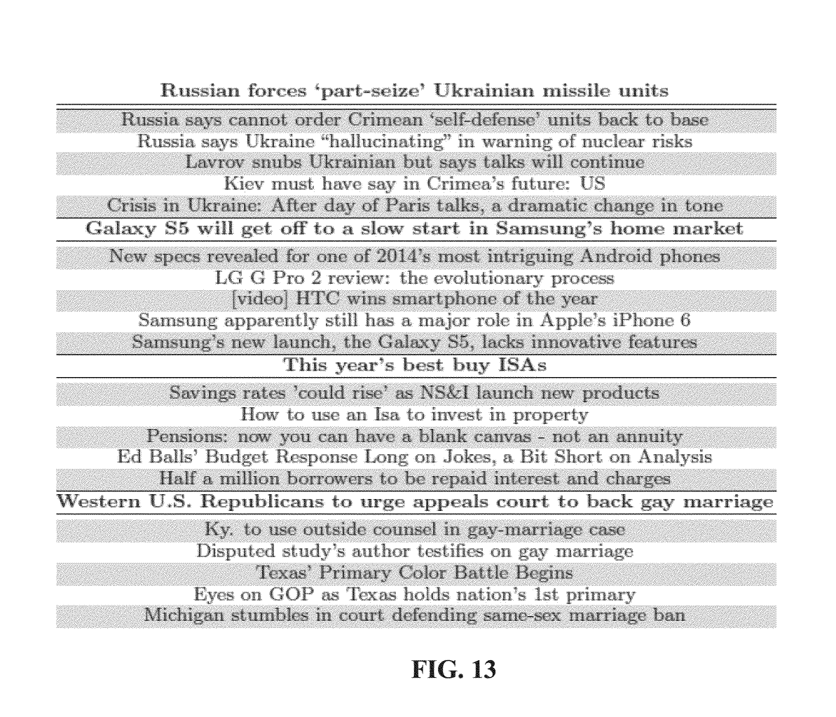

FIG. 13 depicts results of an exemplary experiment for providing titles of news articles for given news examples. In this experiment, the nearest news articles are found for a given news story. The returned articles can be provided as reading recommendations for users viewing the query news story. The examples are shown in FIG. 13, where relevant and semantically related documents are located nearby in the latent vector space. For example, the nearest neighbors for Ukraine-related article are other news stories discussing the Ukraine crisis, while for the article focusing on Galaxy S5 all nearest documents are related to the smartphone industry.

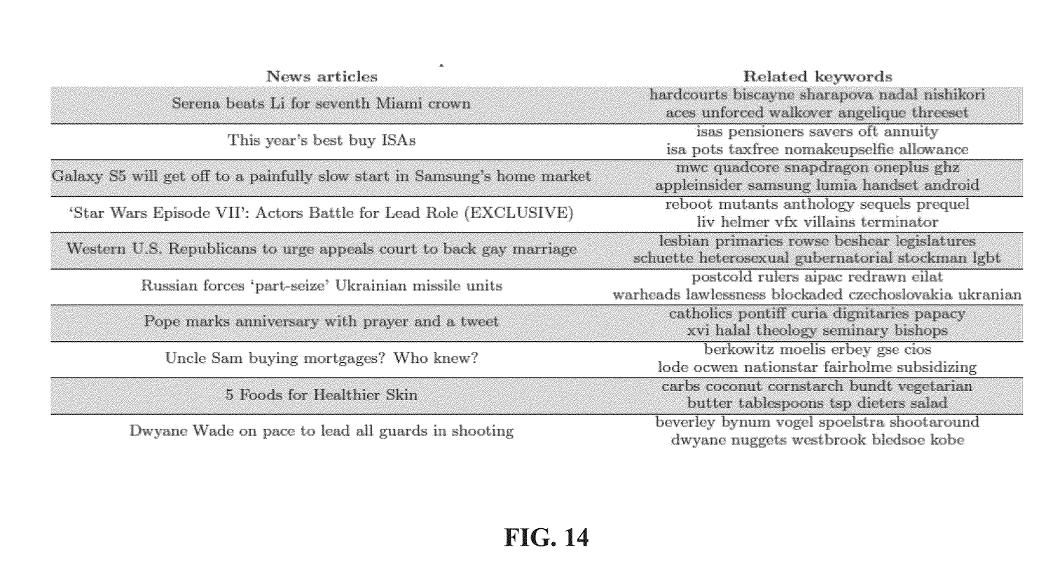

FIG. 14 depicts results of an exemplary experiment for providing top related words for new stories. In this experiment, the nearest words are found given a news story as an input query. The retrieved keywords can act as tags for a news article, or can be further used to match display ads to be shown alongside the article. Automatic document tagging is useful in improving the document retrieval systems, document summarization, document recommendation, contextual advertising (tags can be used to match display ads shown alongside the article), and other applications. The method and system in the present teaching are suitable for such tasks due to the fact that the document and word vectors reside in the same feature space, which allows the method and system to reduce complex task of document tagging to a trivial K-nearest-neighbor search in the embedding space.

Used the trained models, the method and system in the present teaching retrieve the nearest words given a news story as an input. FIG. 14 shows titles of example news stories, together with the list of nearest words. The retrieved keywords often summarize and further explain the documents. For example, in the second example related to Individual Savings Account (ISA) the keywords include “pensioners” and “taxfree,” while in the mortgage-related example (“Uncle Sam buying mortgages? Who Knew?”), keywords include several financial companies and advisors (e.g., Nationstar, Moelis, Berkowitz).

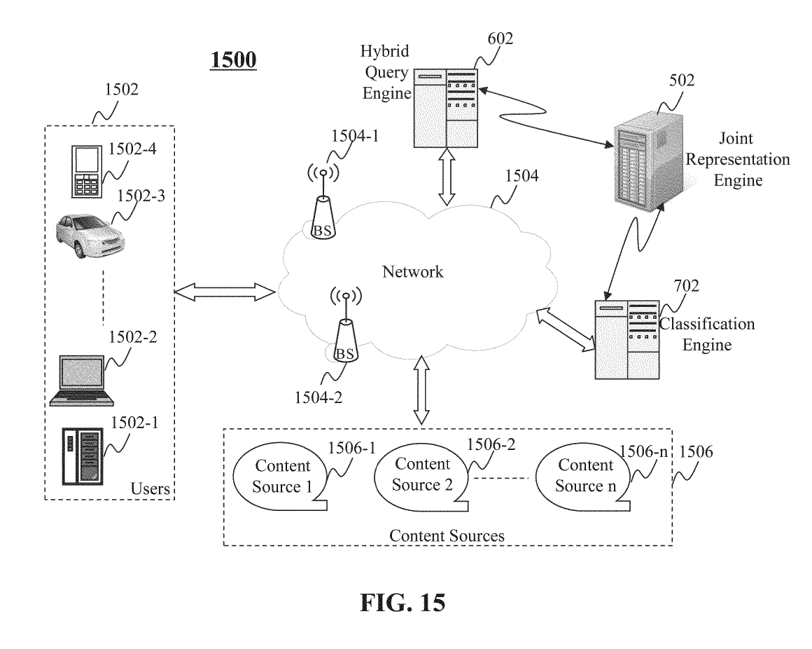

FIG. 15 depicts an exemplary embodiment of a networked environment in which the present teaching is applied, according to an embodiment of the present teaching. In FIG. 15, the exemplary networked environment 1500 includes the joint representation engine 502, the hybrid query engine 602, the classification engine 702, one or more users 1502, a network 1504, and content sources 1506. The network 1504 may be a single network or a combination of different networks. For example, the network 1504 may be a local area network (LAN), a wide area network (WAN), a public network, a private network, a proprietary network, a Public Telephone Switched Network (PSTN), the Internet, a wireless network, a virtual network, or any combination thereof. The network 1504 may also include various network access points, e.g., wired or wireless access points such as base stations or Internet exchange points 1504-1, . . . , 1504-2, through which a data source may connect to the network 1504 in order to transmit information via the network 1504.

Users 1502 may be of different types such as users connected to the network 1504 via desktop computers 1502-1, laptop computers 1502-2, a built-in device in a motor vehicle 1502-3, or a mobile device 1502-4. A user 1502 may send a query in any type (a user group, a user, a document, or a keyword) to the hybrid query engine 602 via the network 1402 and receive query result(s) in any type from the hybrid query engine 602. The user 1502 may also send information in any type (user groups, users, documents, or keywords) to the classification engine 702 via the network 1402 and receive classification results from the classification engine 702. In this embodiment, the joint representation engine 502 serves as a backend system for providing vector representations of any incoming information or similarity measures between any information to the hybrid query engine 602 and/or the classification engine 702.

The content sources 1506 include multiple content sources 1506-1, 1506-2, . . . , 1506-n, such as vertical content sources (domains). A content source 1506 may correspond to a website hosted by an entity, whether an individual, a business, or an organization such as USPTO.gov, a content provider such as cnn.com and Yahoo.com, a social network website such as Facebook.com, or a content feed source such as tweeter or blogs. The joint representation engine 502, the hybrid query engine 602, or the classification engine 702 may access information from any of the content sources 1506-1, 1506-2, . . . , 1506-n.

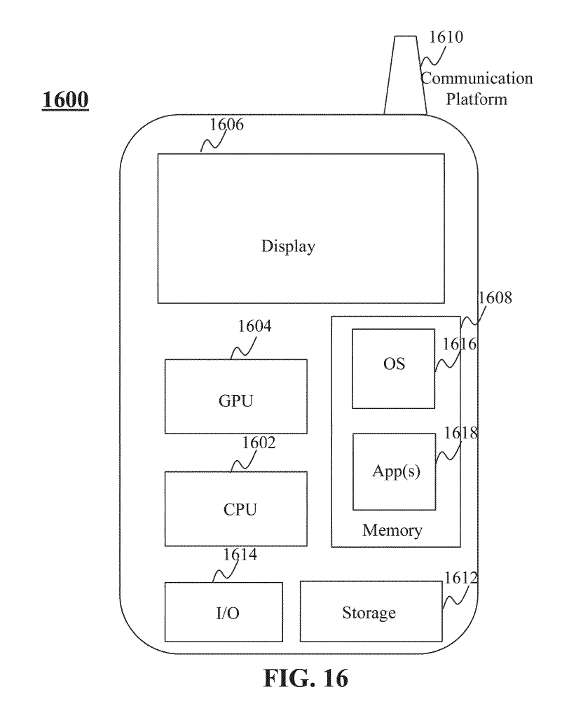

FIG. 16 depicts the architecture of a mobile device which can be used to realize a specialized system implementing the present teaching. In this example, the user device on which content and query results are presented and interacted-with is a mobile device 1600, including, but is not limited to, a smart phone, a tablet, a music player, a handled gaming console, a global positioning system (GPS) receiver, and a wearable computing device (e.g., eyeglasses, wrist watch, etc.), or in any other form factor. The mobile device 1600 in this example includes one or more central processing units (CPUs) 1602, one or more graphic processing units (GPUs) 1604, a display 1606, a memory 1608, a communication platform 1610, such as a wireless communication module, storage 1612, and one or more input/output (I/O) devices 1614. Any other suitable component, including but not limited to a system bus or a controller (not shown), may also be included in the mobile device 1600. As shown in FIG. 16, a mobile operating system 1616, e.g., iOS, Android, Windows Phone, etc., and one or more applications 1618 may be loaded into the memory 1608 from the storage 1612 in order to be executed by the CPU 1602. The applications 1618 may include a browser or any other suitable mobile apps for receiving and rendering content streams and query results on the mobile device 1600. User interactions with the content streams and query results may be achieved via the I/O devices 1614 and provided to the hybrid query engine 602 and/or the classification engine 702 via the network 1504.

To implement various modules, units, and their functionalities described in the present disclosure, computer hardware platforms may be used as the hardware platform(s) for one or more of the elements described herein (e.g., the joint representation engine 502, the hybrid query engine 602, the classification engine 702, described with respect to FIGS. 1-15). The hardware elements, operating systems and programming languages of such computers are conventional in nature, and it is presumed that those skilled in the art are adequately familiar therewith to adapt those technologies to information representation as described herein. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

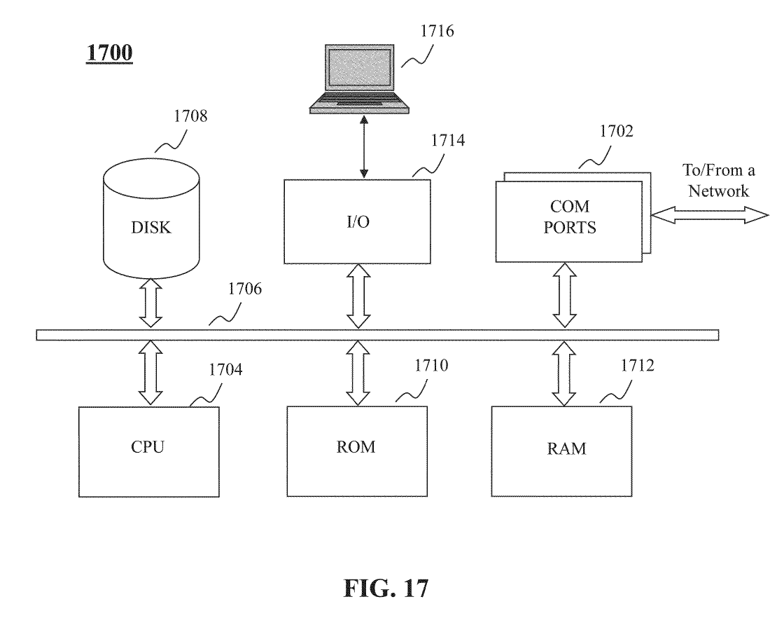

FIG. 17 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 1700 may be used to implement any component of joint information representation techniques, as described herein. For example, the joint representation engine 502, etc., may be implemented on a computer such as computer 1700, via its hardware, software program, firmware, or a combination thereof. Although only one such computer is shown, for convenience, the computer functions relating to joint information representation as described herein may be implemented in a distributed fashion on a number of similar platforms, to distribute the processing load.

The computer 1700, for example, includes COM ports 1702 connected to and from a network connected thereto to facilitate data communications. The computer 1700 also includes a central processing unit (CPU) 1704, in the form of one or more processors, for executing program instructions. The exemplary computer platform includes an internal communication bus 1706, program storage and data storage of different forms, e.g., disk 1708, read only memory (ROM) 1710, or random access memory (RAM) 1712, for various data files to be processed and/or communicated by the computer, as well as possibly program instructions to be executed by the CPU 1704. The computer 1700 also includes an I/O component 1714, supporting input/output flows between the computer and other components therein such as user interface elements 1716. The computer 1700 may also receive programming and data via network communications.

Hence, aspects of the methods of joint information representation and/or other processes, as outlined above, may be embodied in programming. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of a search engine operator into the hardware platform(s) of a computing environment or other system implementing a computing environment or similar functionalities in connection with joint information representation. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the enhanced ad serving based on user curated native ads as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method implemented on at least one computing device each of which has at least one processor, storage, and a communication platform connected to a network for determining similarity between information, the method comprising:
receiving a first piece of information and a second piece of information, wherein each of the first and second pieces of information relates to one word in a plurality of documents, one of the plurality of documents, or one of user to which the plurality of documents are given;
obtaining a model for estimating feature vectors of the first and second pieces of information, wherein the model comprises a first neural network model based, at least in part, on a first order of words within one of the plurality of documents and a second neural network model based, at least in part, on a second order in which at least some of the plurality of documents are given;
estimating, based on the model, a first feature vector of the first piece of information and a second feature vector of the second piece of information; and
determining a similarity between the first and second pieces of information based on a distance between the first and second feature vectors.

2. The method of claim 1, further comprising:
receiving a query that relates to the first piece of information; and
providing the second piece of information as a result of the received query if the determined similarity between the first and second pieces of information is above a threshold.

3. The method of claim 1, further comprising:
classifying the first and second pieces of information based on the determined similarity between the first and second pieces of information.

4. The method of claim 1, wherein
the first neural network model is based, at least in part, on the document that contains the words in the first order; and
the at least some of the plurality of documents given in the second order include the document that contains the words in the first order.

5. The method of claim 4, wherein the second neural network model is based, at least in part, on a user to which the at least some of the plurality of documents are given in the second order.

6. The method of claim 1, wherein the model further comprises a third neural network model based, at least in part, on relationship between at least some of the users to which the plurality of documents are given.

7. The method of claim 1, wherein the first and second feature vectors are estimated by automatically optimizing the model using a hierarchical softmax approach.

8. The method of claim 7, wherein the model is optimized by maximizing log-likelihood of the first order and/or the second order.

9. The method of claim 1, wherein dimensionalities of the first and second feature vectors are the same.

10. A system having at least one processor storage, and a communication platform for determining similarity between information, the system comprising:
a data receiving module configured to receive a first piece of information and a second piece of information, wherein each of the first and second pieces of information relates to one word in a plurality of documents, one of the plurality of documents, or one of user to which the plurality of documents are given;
a modeling module configured to obtain a model for estimating feature vectors of the first and second pieces of information, wherein the model comprises a first neural network model based, at least in part, on a first order of words within one of the plurality of documents and a second neural network model based, at least in part, on a second order in which at least some of the plurality of documents are given;
an optimization module configured to estimate, based on the model, a first feature vector of the first piece of information and a second feature vector of the second piece of information; and
a similarity measurement module configured to determine a similarity between the first and second pieces of information based on a distance between the first and second feature vectors.

11. The system of claim 10, further comprising:
a hybrid query engine configured to receive a query that relates to the first piece of information, and provide the second piece of information as a result of the received query if the determined similarity between the first and second pieces of information is above a threshold.

12. The system of claim 10, further comprising:
a classification engine configured to classify the first and second pieces of information based on the determined similarity between the first and second pieces of information.

13. The system of claim 10, wherein
the first neural network model is based, at least in part, on the document that contains the words in the first order; and
the at least some of the plurality of documents given in the second order include the document that contains the words in the first order.

14. The system of claim 13, wherein the second neural network model is based, at least in part, on a user to which the at least some of the plurality of documents are given in the second order.

15. The system of claim 10, wherein the model further comprises a third neural network model based, at least in part, on relationship between at least some of the users to which the plurality of documents are given.

16. The system of claim 10, wherein the first and second feature vectors are estimated by automatically optimizing the model using a hierarchical softmax approach.

17. A non-transitory computer-readable medium having data recorded thereon for determining similarity between information, wherein the data, when read by the machine, causes the machine to perform the following:
receiving a first piece of information and a second piece of information, wherein each of the first and second pieces of information relates to one word in a plurality of documents, one of the plurality of documents, or one of user to which the plurality of documents are given;
obtaining a model for estimating feature vectors of the first and second pieces of information, wherein the model comprises a first neural network model based, at least in part, on a first order of words within one of the plurality of documents and a second neural network model based, at least in part, on a second order in which at least some of the plurality of documents are given;
estimating, based on the model, a first feature vector of the first piece of information and a second feature vector of the second piece of information; and
determining a similarity between the first and second pieces of information based on a distance between the first and second feature vectors.

18. The medium of claim 17, wherein
the first neural network model is based, at least in part, on the document that contains the words in the first order; and
the at least some of the plurality of documents given in the second order include the document that contains the words in the first order.

19. The medium of claim 18, wherein the second neural network model is based, at least in part, on a user to which the at least some of the plurality of documents are given in the second order.

20. The medium of claim 17, wherein the model further comprises a third neural network model based, at least in part, on relationship between at least some of the users to which the plurality of documents are given.
